(19) United States
(12) Patent Application Publication
(10) Pub. No.: US 2011/0113008 A1
(43) Pub. Date: May 12, 2011

(54) Workflow automation system and method

(76) Inventors: Syed Shomaail Mansoor Jafri, Dhahran (SA); Yasser Shabaan, Redmond, WA (US); Sahel Nashat Abduliauwad, Dhahran (SA)

(21) Appl. No.: 12/591,124

(22) Filed: Nov. 9, 2009

(51) Int. Cl. G06Q 10/00; G06F 17/30; G06F 15/16; G06F 7/00; G06F 17/00

(52) U.S. Cl. 707/608; 707/802; 709/206; 707/E17.005; 715/234; 705/7.27

(57) ABSTRACT

The workflow automation system is a secure online web-based system that automates any office workflow in a minimal amount of time by providing appropriate customizations and ASP.net forms, the customizations including name of the system, task-names, role names, names of actions on each task, order of tasks, etc. After the customizations, the workflow automation system is executable to provide each role; a secure login with a central HR repository; an application that the role is responsible for; active task(s) in the application, etc. The desired web forms can be made in ASP.net using the provided templates for forms, and controls to define what to do when by whom. The workflow automation system includes automatic sending of e-mail reminders to complete tasks after certain administrator-defined intervals, application tracking, parallel and sequential task processing, easy concealment of certain role names from others, and an easy method to provide Instructions on each web page.

### BACKGROUND OF THE INVENTION

1. Field of the Invention

The present invention relates to workflow automation, and more specifically to a workflow automation system and method that includes a secure online web-based system that efficiently automates any office workflow.

2. Description of the Related Art

With the decrease in the price of computer hardware, businesses all round the world are tending to adopt automation of business workflow and avoiding primitive paper based systems. This is due to the apparent advantages like security, alacrity, enhanced management etc. over the paper-based system. Since business workflows are of different types, complexity and nature, a need for a customizable engine is observed that can come up with automation of any workflow. Although, the proposed workflow automation system is not a complete solution but rather to some extent, it can produce automation of any office or business workflow quite easily.

A workflow is simply an ordered series of tasks that accomplish some defined purpose according to a set of rules. There are different types of workflow with respect to the task order. In some workflows, all of the tasks are assigned to roles one after the other, i.e., in a sequential manner. Other workflows have some tasks in parallel and others sequential. Some workflows handle the series of tasks in a forward-only manner, while others handle tasks in a back and forth manner. Hence, different workflow schemes have different complexities and rules.

There have been a number of efforts to automate workflows for the last two decades. The automated workflow systems keep changing with the change in the requirements and environment in the offices.

One of the early approaches for developing automation of workflow is Document Management System (DMS). DMS is a computer system (or set of computer programs) used to track and store electronic documents and/or images of paper. Initially, it was used only for storing and managing paper documents and was typically known for storage of scanned documents and images in electronic form on a server. However, DMS has matured from a basic archival and retrieval system to a complete information management solution. It is now used for making work flow. While DMS has kept on improving continuously over time, flexibility in making complex workflow schemes remains limited. Moreover, DMS is incapable of making complex forms and hiding chunks of information from specified roles (e.g., hiding names of members of a certain committee in a document). Additionally, attempts at workflow automation have not provided a complete general solution, which is needed.

Enterprise Resource Planning (ERP) has been suggested for a complete general solution for entire business process automation. However, ERP is high in cost, not especially suitable for small businesses, and limited in ERP software customization.

Thus, a workflow automation system and method solving the aforementioned problems is desired.

### SUMMARY OF THE INVENTION

The workflow automation system and method includes a secure online web-based system that automates any office workflow in a minimal amount of time by providing appropriate customizations and ASP.net forms, the customizations including: name of the system, task-names, role names, names of actions on each task, order of tasks, etc. After the customizations, the workflow automation system is executable to provide each role with a secure login having a central HR repository; an application the role is responsible for; active task(s) in the application, etc. Subsequently, the desired web forms can be made in ASP.net using the provided templates for forms and controls to define what to do, when, and by whom. The workflow automation system includes automatic sending of e-mail reminders to complete tasks after certain administrator-defined intervals, application tracking, parallel and sequential task processing, easy concealment of certain role names from others, and an easy method to provide Instructions on each web page.

These and other features of the present invention will become readily apparent upon further review of the following specification and drawings.

### BRIEF DESCRIPTION OF THE DRAWINGS

FIG. 1 is a block diagram showing a typical order of tasks in a workflow automation system according to the present invention.

FIG. 2 is a block diagram showing diverging and converging tasks in a workflow automation system according to the present invention.

FIG. 3 is a block diagram illustrating processing layers in a workflow automation system according to the present invention.

FIG. 4 is a flow diagram showing the usual route of a web page request in a workflow automation system according to the present invention.

FIG. 5 is a typical processing environment for a workflow automation system and method according to the present invention.

Similar reference characters denote corresponding features consistently throughout the attached drawings.

### DETAILED DESCRIPTION OF THE PREFERRED EMBODIMENTS

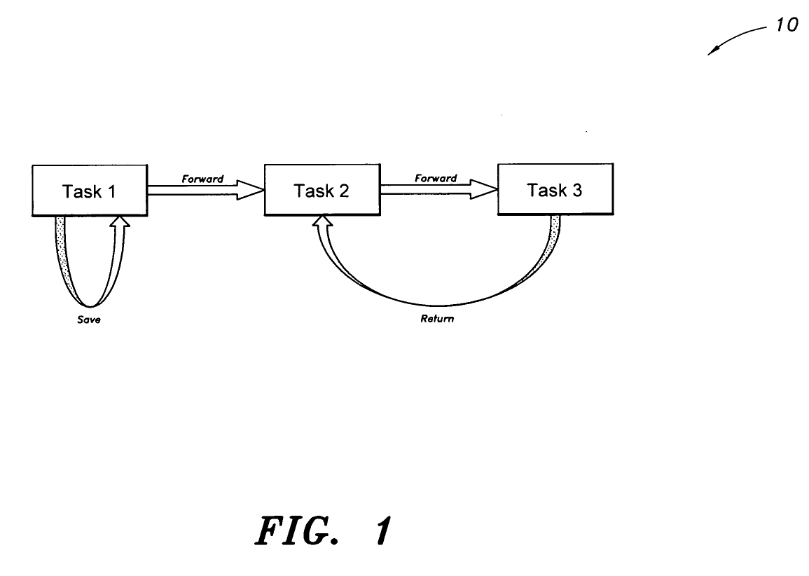

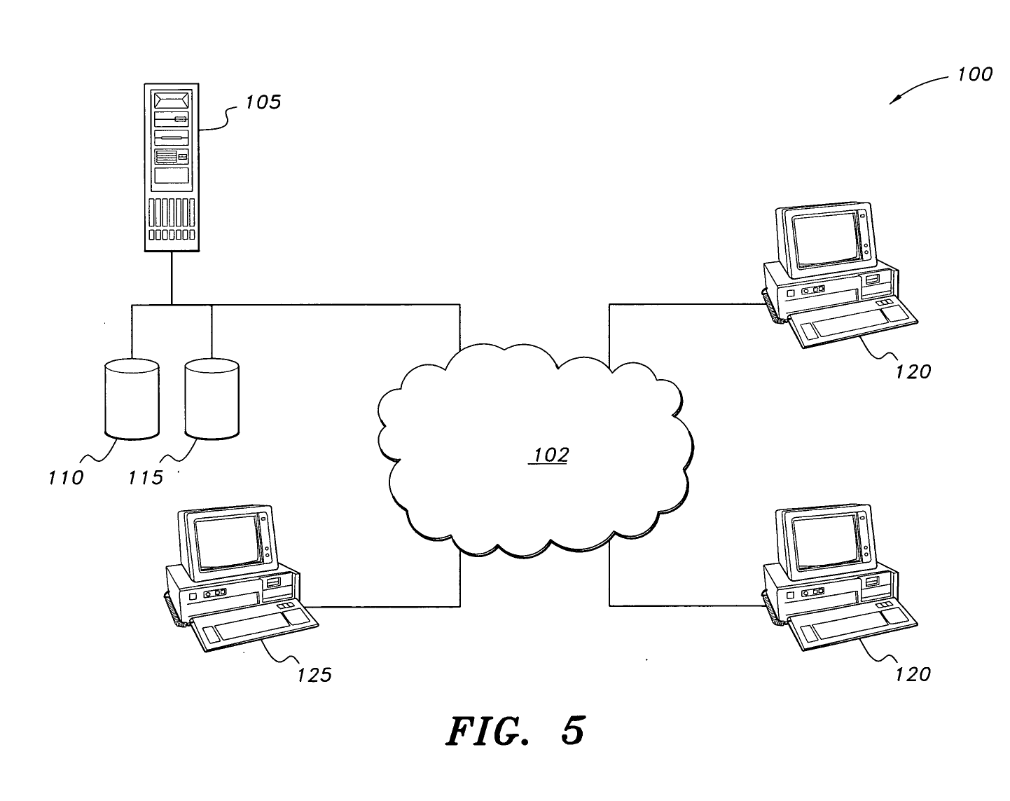

As shown in FIGS. 1-5, the workflow automation system 300 can produce a secure online web-based system 100 to automate any office workflow in a minimal amount of time by providing appropriate customizations and ASP.net forms, the customizations: including name of the system, task-names, role names, names of actions on each task, order of tasks, etc. FIG. 5 shows exemplary computing environment 100 that the workflow automation system 300 can run in. Exemplary server 105 hosts web pages stored on mass storage device 110 and hosts a DBMS having access to databases stored on mass storage device 115. While a single server platform 105 is shown, the workflow automation system 300 can be distributed across multiple networked servers. Similarly, web page storage and database storage may be accomplished via a plurality of mass storage devices, such as MSU's 110 and 115, in a variety of configurations. User devices 120 access the web pages via the Internet 102. Administrator device 125 accesses administrative functions related to web page development and DBMS maintenance via the Internet 102.

After the customizations, the workflow automation system 300 is executable to provide each role with a secure login having a central HR repository; an application that the role is responsible for; active task(s) in the application, and the like. Subsequently, the desired web forms can be made in ASP.net using the provided templates for forms and controls to define what to do, when, and by whom, i.e., the business logic of the workflow and tasks. The workflow automation system includes automatic sending of e-mail reminders to complete tasks after certain administrator-defined intervals, application tracking, parallel and sequential task processing, easy concealment of certain role names from others, and an easy method to provide Instructions on each web page.

The workflow automation system is a framework for building automation of workflows. It provides user-friendly forms for providing information, such as name of the system, Tasks, Roles, and Action etc. This information is further used for defining the workflow. Once the workflow is constructed, Forms can be made using the available templates for defining specifically the task for every role. These Forms are made in ASP.net 2.0. The system facilitates the roles performing tasks by automatically sending e-mail reminders to complete tasks after certain administrator-defined interval. The system facilitates users to see the tracking information of all the tasks present in the workflow, with the task names, person name, and role name and the time of action along with the duration each role is taking. With some easy adjustment in defining Task and Action while building the automation, tasks can be made which can be ordered sequential as well as parallel. This feature allows complex workflow requirements to be automated with ease. The roles present in the system are shown information only relevant to them. The administrator can show and hide any chunk of information in the dynamic reports from one role to the other with the help of available forms while defining the system. Apart from this, the names of person performing actions in the Action History can also be made to hide for unwanted roles. The system provides a user friendly GUI for the administrator to add/edit instruction present on each web page.

The workflow automation system helps user to make logical workflow of any business or office system. The procedure follows some known steps. Before we start building the system there are some minor preliminary requirements that need to be fulfilled as well. We describe these requirements followed by the steps for building the automation and subsequently we discuss the running of the automation.

The workflow automation system is meant to automate businesses with an established e-mail system and a central repository of employee details and department organization. The employee detail must include ID, Name, Department, employee's e-mail ID (organization e-mail). Whereas, the Department organization must contain the list of all departments with their Department Heads' employee ID. If such a repository is not present then the system provides forms for making the repository. However, the e-mail system is a necessary pre-requisite of the workflow automation system. Now, we proceed to define the steps for making an automation system. Forms are provided to complete each step in the workflow automation system with the administration login.

The system is defined by three fields, namely: System Full Name, System Short Name, and Complete URL. The full name appears on each web page as title and in the Footnote whereas the short name is used for the system e-mail ID. (e.g., ABCSystem@organization.com here “ABCSystem” is the short name of the system)

Every role is assigned a Role ID, a Role Name and a Level in organization hierarchy. A higher level denotes a higher level in the organization hierarchy. For e.g. the level of a staff is less than the level of his immediate boss and so on. The levels can be same as well.

A Phase is defined by a Phase ID and Phase Title. If two tasks are defined to be run in parallel then each has the same phase ID.

Each task is assigned a Task ID, a Phase ID, a Task Title, the Role ID of the role the task is assigned to, first reminder duration (in days) and Second and later reminders duration (in days).

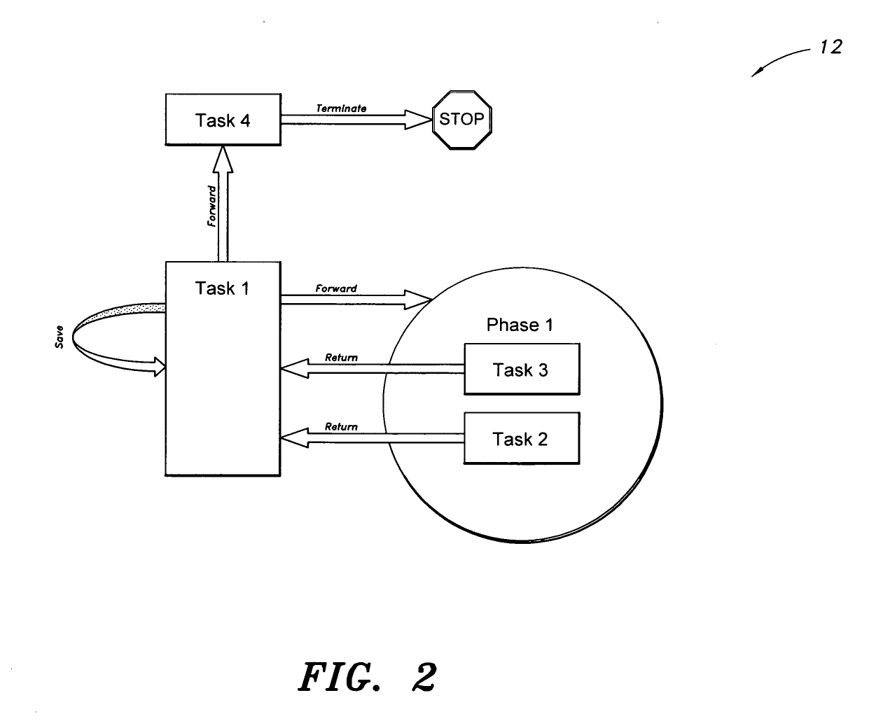

As shown in FIG. 1, tasks 10 may have a forward progress from task to task including a “Save” loop and a “Return”, i.e., feedback loop to a previous task. As shown in FIG. 2, tasks 12 may be converging as between tasks 1, 2 and 3, or the tasks may be diverging, as between tasks 1 and 4. Every action related to a task is defined by an Action ID, Action Title, Action Type, Task ID of the task holding the action and either a next Task ID or a next Phase ID. A phase ID is used when the action is to fork into more than one parallel task. Action Type is a set of some pre-defined actions that a role can take when assigned a task. These include: Forward, Return, Save, Terminate, etc. The Action may lead the role to complete the task (e.g., Save), initiate a new task (e.g., Forward), return to the previous task (e.g., Return) or finish the workflow (e.g., Terminate).

Each form is defined by a Form ID, the title of the page and the name of ASP.net form (along with extension “.aspx”).

A task is a set of forms assigned to a role present in the system. The names of each form appear as menu items in the left pane when the task is opened by the user. Some forms are necessary to be filled and saved by the user and others are optional. We define here each task with the Task ID, Form ID, the rank/position of the form name in the menu, a level (which represents some privileges when a single form is to be shown to two different roles), Instructions that appears on the top of each form and a Boolean field representing that the form is necessary or optional for the completion of the task.

When a task is completed with a start of another task, an e-mail is sent to the role associated with the next tasks. The e-mail template for this e-mail is to be defined here. It is defined by an Action ID, the next Task ID, and the message. In the table below, the variables that can be used in the template are described. Their values are fetched at run time.

TABLE I
E-Mail Templates

| S. | | |
|---|---|---|
| No. | Variable in E-mail Templates | Description |
| 1 | @@Applicant@@ | The initiator of the |
| | | request/application |
| | | in the workflow |
| 2 | @@ApplicantDepartment@@ | Applicant's |
| | | Department Name |
| 3 | @@Receiver@@ | The Name of the |
| | | Person responsible |
| | | for the next task |
| 4 | @@ReceiverDepartment@@ | Receiver's |
| | | Department Name |
| 5 | @@Sender@@ | The Name of the |
| | | Person responsible |
| | | for the Current Task |
| 6 | @@SenderDepartment@@ | Sender's |
| | | Department Name |

With the aforementioned eight steps, we are done with making the skeleton of the workflow. The workflow can now be accessed on the URL mentioned. The forms now need to be constructed using the available ASP.net Forms and Controls templates.

The workflow automation system 300 is designed to provide a secure web-based automation of workflow on the URLs specified in the system properties in step 1. A workflow is typically an application that is initiated by a specified role and later it moves through specific tasks assigned to different roles in different offices. Order of tasks related to an application can be forward, backward, diverging or converging as discussed above.

At first, the system authenticates each user with Lightweight Directory Access Protocol (LDAP) authentication or any other authentication system later customized. After authentication, the system displays the: (1) User detail; (2) Application(s) the user is responsible for, along with his role in the application; and (3) Option to start a new workflow.

By default, the system provides every user the option to start a new workflow. However, this can be customized to limit only specific or desired users.

The signed-in user can now open the application he is responsible for, to see the currently active task(s) related to the application. If any of the active task(s) belongs to him, he will be able to see an Open link otherwise he will be able to see Waiting text along with the name of the user, the task is active for. Also, at this stage, he can view the action history of the application as well. This history includes all Task Names, Names of the Person assigned with their role and the time of the Actions along with the duration in days and hours each person took to complete the tasks in this application.

If the active task belongs to the signed-in user, he/she can click on the Open link to open the electronic application. The electronic Application is comprised of menu items on the left side. Each menu item corresponds to a form. Clicking on the menu item opens the form. If the form is necessary to be filled for the completion of task then a Save button will appear at the bottom of the form otherwise it will not appear.

The last menu item is Action. Clicking on the Action menu item opens a checkout form that shows the checklist of Forms necessary to complete the task and their status (Complete/incomplete). The checkout form also has the list of actions that a user can take on this specific task. Some actions, such as Return and Save do not require the checklist of Forms to be completed. Actions such as Forward require all necessary forms to be completed. Performing a Forward or Return action opens a compose e-mail control with a “Confirm Selected” Action button. The e-mail has the editable text for requesting action after the application is returned or forwarded. As the task is forwarded or returned, the e-mail is sent to the user responsible for the next task.

This concludes the current user's active task. After forwarding or returning the application, the user can no longer access the forms in the application. However, the user will be able to see the changing history of tasks on the application.

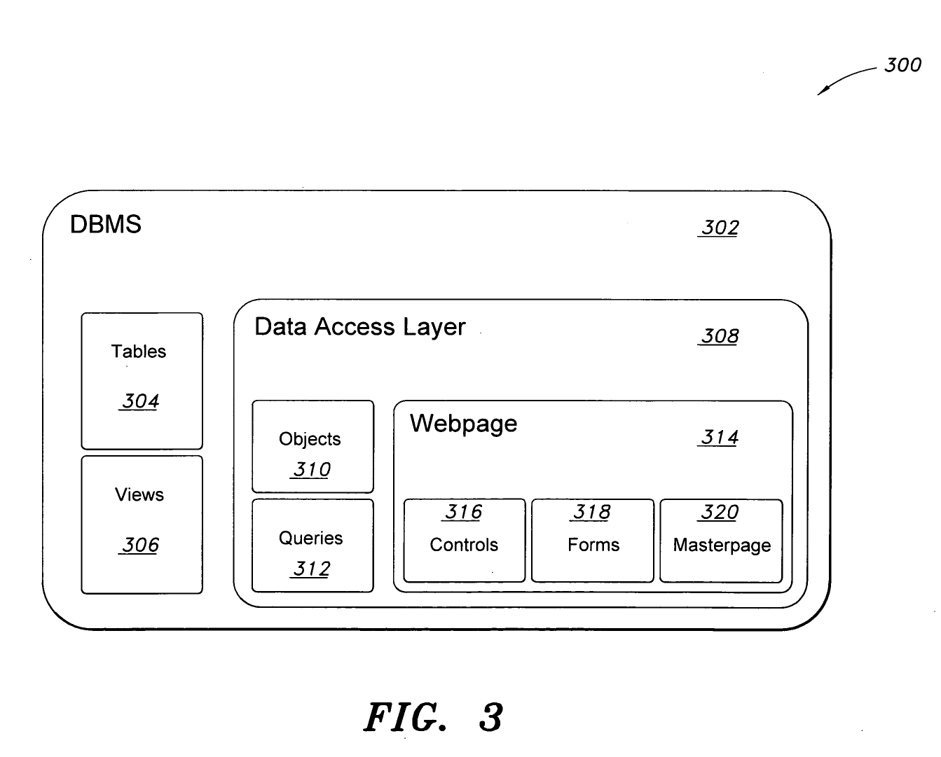

As shown in FIG. 3, the system 300 is designed with a Layered Architecture defining three different logical layers. The bottom-most layer is the DBMS layer 302, followed by Data Access Layer 308 and finally the Webpage Layer 314.

The first layer is the DBMS layer 302, which includes Tables 304 and Views 306. Above DBMS layer 302 is the Data Access Layer 308 (DAL), which includes objects and queries. All the SQL queries are in the DAL 308. The DAL 308 has 7 files in workflow automation system 300. Web pages layer 314 is disposed over the DAL 308. Web pages layer 314 includes Forms 318, Master pages 320 and Controls 316.

In the DBMS layer 302, the raw data is stored in the form of tables 304. Apart from this, in order to increase the ease of accessing and avoiding complex queries on the Data Access layer 308, Views 306 over some of the tables 304 are also stored in DBMS layer 302. Constraints, such as primary key, foreign key, and the like, are stored along with the tables 304 in DBMS layer 302.

The Data Access layer 308 includes Data Access Layer files having extension “.xsd”. These files contain objects for accessing one or more tables 304 or views 306 in Database layer 302. Each object is linked with the Data in the DBMS 302 through a connection string, which is stored in a configuration file on the web server 105. The connection string contains the name of the Data source (server name), the initial catalog (Database name), user ID and password. Along with the connection string, the provider name is also stored. In the usual practice, one object is linked with one table or view. The object contains the attributes of the table or view and the queries that will be used to access the data.

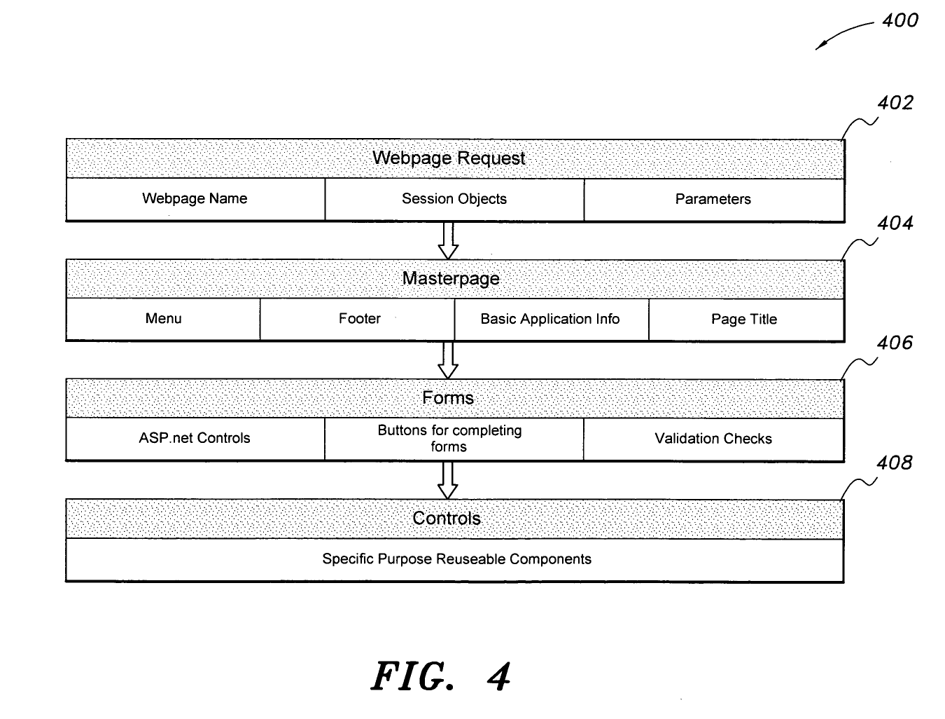

The web page layer 314 receives the data manipulation requests from the user or the system and shows the results of the actions. The web pages use the objects of the DAL 308 to form Adapters. The Adapters allow the web page to access the query methods of the Objects. Operational flow 400 of the web page layer 314 is shown in FIG. 4 where it can be observed that a web page request 402 results in master page presentation 404 to the end user who then selects from a menu in order to proceed to the forms presentation 406. The user then clicks on buttons for completing forms, which results in specific controls presentation 408. All of the aforementioned presentations to the end user are determined according to the business logic specified by the administrator. The following code shows how the adapter object is formed (first line) and how the Adapter is used to extract data using the GetApplicant method that contains the query:

TABLE II
Adapter Object code

PromotionTableAdapters.EmpTableAdapter adapter=new
PromotionTableAdapters.EmpTableAdapter( );
Promotion.EmpDataTable table = adapter.GetApplicant(applicationID);

The Workflow Automation system includes a front end design and a Back end Database Design.

In the front end design, the WebPages include reusable components known as user defined controls. As shown in FIG. 4 a web request is routed from the web server 105 and finally reaches the controls at the end. As a web page is requested by the server 105, the master page 320, along with the form and controls are made in the order shown in FIG. 4.

There are 43 Database Tables 304. The tables are grouped into 7 classes depending upon the data and its usage in the system. These include Workflow Tables, which are mainly responsible for maintaining workflow from one task to the other. Within the Workflow tables are static tables, which define the main workflow of the application. Definitions of the course of action, privileges, instructions, etc., are included in the static tables.

TABLE III
Description of Static Workflow Tables

| Static Workflow Tables | Description |
|---|---|
| Action | All the actions that a role |
| | can be performed with respect |
| | to the task assigned are stored |
| | here. |
| ActionMessage | The template of the |
| | message that becomes the |
| | contents of the e-mail when a |
| | new task is started. The e-mail |
| | is sent to the role responsible |
| | for the task and will also |
| | appear as the role opens the |
| | application. |
| Form | All the ASP.NET Forms |
| | and their titles are stored here. |
| | These titles are used for menu |
| | generation. |
| Phase | In case of parallel |
| | processes, the task is |
| | overlooked by the Phase. The |
| | Phase ID and Title are stored |
| | here. |
| Role | The Role represents the |
| | different categories of faculty, |
| | e.g., Applicant, Chairman, |
| | Dean, etc. |
| Task | All the tasks with |
| | corresponding Role and Phase |
| | (in case of parallel processes) |
| | are stored here. Also the |
| | number of days the system will |
| | wait for sending the first and |
| | subsequent reminders if the |
| | task is not completed are also |
| | stored corresponding to each |
| | task. |
| TaskForm | Information of which |
| | forms are shown for each task |
| | and which forms are necessary |
| | to complete in order to |
| | complete the task is stored |
| | here. |

Additionally, the workflow tables include dynamic tables, which are prefixed with “Application_”. The data in these tables are dynamically changed as the application is moved from one role to the other or a task is being completed.

TABLE IV
Description of Dynamic Workflow Tables

| Dynamic Workflow Tables | Description |
|---|---|
| Application | This table corresponds |
| | to one application or project |
| | that is comprised of different |
| | tasks. |
| Application_Role | This table stores the |
| | role corresponding to an |
| | application. The role is |
| | determined by the employee |
| | ID |
| Application_TaskForm | The information |
| | regarding each task in an |
| | application. Which form is to |
| | be shown in which task and |
| | what instructions should be |
| | displayed on the page/form. |
| Application_Log | This table is used for |
| | building history. It stores all |
| | the events. |
| Application_TaskLog | This table specifies |
| | whether the task is |
| | completed or not. |

With respect to First Level Form Tables, all the forms have direct links with the First Level Form tables through Data Access layer 308. All these tables are prefixed with “Form_”.

With respect to Second Level Form Tables, these tables are directly linked with the First Level Form Tables. Forms do not access these tables directly.

The Human Resource Tables are static tables that are synchronized with the Human Resource Database of the company. These tables include Employee Detail and department organization as discussed in the preliminaries.

Report parameters are fetched from the Report Parameters Table in the forms with report control. The table is prefixed with “Report”. The parameters are used in the reports and their values present in the table to allow the items in the reports to be shown or to be hidden. This allows small chunks of information to be hidden from specific roles.

With the help of the above mentioned tables and SQL queries that run over them, the system is designed in such a way that only the desired user(s) at a time can access and open the application. All the other Application roles are shown the application in a waiting state with the name of the person the task is assigned to. All roles can witness the action tracking of the application by opening the application's active task. Also with the help of some complex queries the rules are made for forwarding, returning the application to one or more recipients quite easily by changing the Action and Task table with the help of Forms available. This relieves the developers from the necessity of writing complex queries.

The workflow automation system provides a framework for building automation of businesses and primitive paper based systems. It helps in managing information as well as providing reports for the high-level authorities for critical business decision.

An engine or framework for automating the workflows in businesses or offices is presented. The Workflow Automation system 300 provides developers an easy and user-friendly environment for developing complex workflows without any need of writing complex queries in a minimal amount of time. With some definite steps of customization, the workflow skeleton is ready to run, providing each role a secure login on a web-based system. The Forms for each role can be made using the available ASP.net and C# forms and control templates for defining specific task of each user, i.e., what to do when and by whom.

The advanced features of the system 300 include automatic sending of e-mail reminders to complete tasks, Application tracking, Processing of Parallel and Sequential Tasks, Easy concealment of certain role names from others, Easy method to provide Instructions on each web page, and the like.

It is to be understood that the present invention is not limited to the embodiment described above, but encompasses any and all embodiments within the scope of the following claims.

We claim:

1. A workflow automation system, comprising:
a plurality of databases holding workflow tables maintaining workflow for a plurality of tasks;
a database management system managing the plurality of databases;
dynamic web pages;
a server computer hosting the DBMS and the dynamic web pages, the server computer having means for accessing a network, the server computer having means for publishing a web site on the network, the web site being accessible to end user client devices and administrator client devices, thereby allowing an administrator access to the server and allowing an end user access to the dynamic web pages;
means for administrator access to the database management system, the means for administrator access including means for allowing the administrator to define business logic of the workflows and the tasks;
means for establishing a database management system layer managing views and the workflow tables;
means for establishing a Data Access layer managing objects and queries related to the workflow tables and the views, the Data Access layer being in operable communication with the database management layer; and
means for establishing a Web page layer managing controls, forms and master pages, the Web page layer being in operable communication with the Data Access layer;
wherein the end user can interact with the dynamic web pages according to the workflow and task business logic defined by the administrator.

2. The workflow automation system according to claim 1, further comprising means for automatically sending e-mail reminders to complete tasks after preselected administrator-defined intervals.

3. The workflow automation system according to claim 1, further comprising means for establishing a web application framework allowing the administrator to rapidly design and deploy said dynamic web pages according to the business logic.

4. The workflow automation system according to claim 3, wherein the web application framework includes means for allowing forms to be made using available templates for specifically defining a task depending on a class of end user.

5. The workflow automation system according to claim 1, further comprising means for customizing name of the system, task-names, role names, names of actions on each task, and order of tasks.

6. The workflow automation system according to claim 1, further comprising means for providing a secure login for all classes of end users.

7. The workflow automation system according to claim 1, further comprising means for tracking objects in the workflow.

8. The workflow automation system according to claim 1, further comprising means for parallel and sequential task processing.

9. The workflow automation system according to claim 1, further comprising means for easy concealment of certain classes of users from other classes of users, wherein only relevant information according to user class is shown to the users.

10. The workflow automation system according to claim 1, further comprising means for allowing users to see tracking information of all said tasks present in said workflow, with task names, person name, and role name and the time of action along with the duration each role is taking.

11. The workflow automation system according to claim 1, further comprising means for providing an action history recording action on said dynamic web pages taken by said end users, names of persons performing said action being hideable from administrator defined classes of said end users.

12. The workflow automation system according to claim 1, further comprising:
means for defining properties of said workflow automation system;
means for defining all roles/user classes, involved in said workflow automation system;
means for defining all phases for parallel execution of a task, each of said phases being defined by a Phase ID and Phase Title, parallel executing tasks having a same Phase ID;
means for defining all tasks involved in said workflow, wherein each task is assigned a Task ID, a Phase ID, a Task Title, said Role ID of said role said task is assigned to, a first reminder duration, and subsequent reminder durations;
means for defining actions related to each task, every action related to a task being defined by an Action ID, Action Title, Action Type, Task ID of the task holding the action, and, a next Task ID/Phase ID depending on whether the action is to fork into more than one parallel task;
means for defining forms used in the workflow automation system, wherein each form is defined by a Form ID, title of page, and name of form;
means for defining forms related to each task, wherein a task is a set of forms assigned to a role present in the system;
means for defining e-mail templates for each action after task completion, wherein an e-mail is sent to a role associated with a successor task upon completion of the immediate task, said e-mail template being defined by an Action ID, a next Task ID, and a message.

13. The workflow automation system according to claim 1, wherein the workflow tables include static tables defining the main workflow of the application.

14. The workflow automation system according to claim 1, wherein the workflow tables include dynamic tables, the dynamic tables being dynamically changed as the workflow moves from one role to another role or as a task is being completed.

15. A computerized workflow automation method, comprising the steps of:
defining properties of a workflow automation system;
defining all roles/user classes, involved in the workflow automation system;
defining all phases for parallel execution of a task, each of the phases being defined by a Phase ID and Phase Title, parallel executing tasks having a same Phase ID;
defining all tasks involved in the workflow, wherein each task is assigned a Task ID, a Phase ID, a Task Title, the Role ID of the role the task is assigned to, a first reminder duration, and subsequent reminder durations;
defining actions related to each task, every action related to a task being defined by an Action ID, Action Title, Action Type, Task ID of the task holding the action, and, a next Task ID/Phase ID depending on whether the action is to fork into more than one parallel task;
defining forms used in the workflow automation system, wherein each form is defined by a Form ID, title of page, and name of form;
defining forms related to each task, wherein a task is a set of forms assigned to a role present in the system;
defining e-mail templates for each action after task completion, wherein an e-mail is sent to a role associated with a successor task upon completion of the immediate task, the e-mail template being defined by an Action ID, a next Task ID, and a message.

16. A computer product for workflow automation, the product comprising a medium readable by a computer, the medium having a set of computer-readable instructions stored thereon executable by a processor when loaded into main memory, the instructions including:
a first set of instructions that, when loaded into main memory and executed by the processor, cause the processor to define properties of said workflow automation system;
a second set of instructions that, when loaded into main memory and executed by the processor, cause the processor to define all roles/user classes, involved in said workflow automation system;
a third set of instructions that, when loaded into main memory and executed by the processor, cause the processor to define all phases for parallel execution of a task, each of said phases being defined by a Phase ID and Phase Title, parallel executing tasks having a same Phase ID;
a fourth set of instructions that, when loaded into main memory and executed by the processor, cause the processor to define all tasks involved in said workflow, wherein each task is assigned a Task ID, a Phase ID, a Task Title, said Role ID of said role said task is assigned to, a first reminder duration, and subsequent reminder durations;
a fifth set of instructions that, when loaded into main memory and executed by the processor, cause the processor to define actions related to each task, every action related to a task being defined by an Action ID, Action Title, Action Type, Task ID of the task holding the action, and, a next Task ID/Phase ID depending on whether the action is to fork into more than one parallel task;
a sixth set of instructions that, when loaded into main memory and executed by the processor, cause the processor to define forms used in the workflow automation system, wherein each form is defined by a Form ID, title of page, and name of form;
a seventh set of instructions that, when loaded into main memory and executed by the processor, cause the processor to define forms related to each task, wherein a task is a set of forms assigned to a role present in the system;
an eighth set of instructions that, when loaded into main memory and executed by the processor, cause the processor to define e-mail templates for each action after task completion, wherein an e-mail is sent to a role associated with a successor task upon completion of the immediate task, said e-mail template being defined by an Action ID, a next Task ID, and a message; and
a ninth set of instructions that, when loaded into main memory and executed by the processor, cause the processor to provide an easy method to provide instructions on each webpage by the Administrator.
